(19) United States
(12) Patent Application Publication
(10) Pub. No.: US 2007/0083433 A1
(43) Pub. Date: Apr. 12, 2007

(54) System and method for sellers to reward buyer opt-in and repeat purchases using payment transfer agent coupons codes

(76) Inventor: Tabbatha Christie Lawe, Chapel Hill, NC (US)

Correspondence Address: ALUN L. PALMER, PATENT AGENT, 4300 PINEY CHURCH ROAD, WALDORF, MD, 20602, US

(21) Appl. No.: 11/529,820

(22) Filed: Sep. 29, 2006

Related U.S. Application Data
(60) Provisional application No. 60/722,572, filed on Oct. 1, 2005.

(51) Int. Cl. G06Q 30/00

(52) U.S. Cl. 705/14

(57) ABSTRACT

A system and method for operating a buyer reward system used by one or more sellers independent of market venue or ecommerce software to reward buyers with a discount for opting-in to the seller's reward program and email list and for making subsequent purchases; said reward disbursed using payment transfer agent coupon codes entered during buyer payment via the specific payment transfer agent. The reward system assigns and activates an opt-in first payment transfer agent coupon code for a seller to offer buyers purchasing from the registered seller. Next, the reward system creates a unique computer graphic image or specific text for the seller to present the opt-in payment transfer agent coupon code to potential buyers at the point-of-sale on an HTML selling page. To receive the reward, as instructed in the image, the buyer uses the seller's displayed opt-in payment transfer agent coupon code during the payment transaction using the named payment transfer agent. The payment transfer agent executes its processes and debits the buyer's payment transfer agent account for the expected amount less the reward defined by the coupon code. The reward system captures and processes the opt-in payment transaction information to subsequently create, activate and send subsequent payment transfer agent coupon codes to the newly opted-in buyer via periodic email messages which stimulate buyer purchase. When a buyer returns to make a repeat purchase, the buyer uses a subsequent payment transfer agent coupon code to receive a reward in the form of a discount off the repeat purchase when paying through the specified payment transfer agent system. The system also has the functionality to send messages to the payment transfer agent to deactivate any or all coupon codes upon certain events.

This application claims benefit of my provisional application 60/722572 filed Oct. 01, 2005.

### BACKGROUND OF THE INVENTION

1. Field of the Invention

This invention relates generally to systems and methods for a reward system used by one or more sellers to reward buyers with a discount for opt-ing-in to a reward program and mail list and for making subsequent purchases; said reward disbursed using payment transfer coupon codes during payment with a specific payment transfer agent. The invention also stimulates repeat transactions by creating and sending emails with subsequent coupon codes to the opted-in buyer for use with the offering seller. This invention operates in conjunction with auctions or fixed price purchases executed on any market venue web sites or via any ecommerce web sites over networks including the Internet when payment is made between a buyer and seller using a specific internet-based payment transfer agent.

2. Background of the Invention

Customer reward programs involving rebates exist in many forms. These reward programs have the objective of attracting and retaining buyers for a seller under various economically efficient ways. A reward program can be uniquely designed and executed to best optimize the objectives of the seller while imposing appropriate major processes on the buyer all within the specific context of the buying/selling environment. The most familiar reward programs are those of airlines. Airline frequent flyer programs demonstrate highly optimized reward programs for their unique environment. Sellers, in this case airlines, have created a reward system which tracks airline miles and/or segments flown for buyers. Many airline reward programs also automatically calculate miles awarded based on prices paid. Buyers, in this case passengers, are provided with specific mileage hurdles to achieve a reward. The rewards are generally granted automatically by airline reward systems when a buyer reaches the mileage hurdle. A buyer only has to request her free tickets or class upgrades to receive them. Buyers are not required to mail in proof-of-flight (e.g. ticket stubs). Moreover, tracking of flights is automated by the airline reward systems. The combination of major processes for an airline reward system include establishing mileage hurdles, automating tracking of miles and incorporating an automated redemption process for valuable rewards. Such a reward system exemplifies the kind of process optimization within their environment which all reward programs seek to encompass. Optimization comes in the form of both increasing seller revenue through stimulating additional sales to the same buyer, while minimizing seller costs by implementing the reward program in an efficient manner using systems.

Failures of reward programs can often be traced to a disconnect between the major processes of the reward program and the environment in which the reward program operates. In many cases, the engagement process for the buyer is complex or the tracking of the rewards is to onerous or the reward process is too involved for the buyer to warrant participation based on the transaction environment.

To those not schooled in the art, the variety of reward programs can be thought of like different compositions of a “virtual fastener.” Each reward program is intended to bind a buyer and a seller together over time under specific environmental conditions defined by when, how, and why a buyer is rewarded for purchases with the sponsoring seller. In this “virtual fastener” analogy, those not schooled in the art can perhaps understand how unique reward programs can be invented to optimize binding a buyer to a seller in unique environments. For instance, one can easily understand that a specific glue fastener can be created which is optimized to join different elements. Two pieces of a child's toy can efficiently be joined by a generic glue fastener, while an entirely different fastener would be required to efficiently join two parts on a space shuttle. These two different fasteners would naturally have entirely different properties and materials and each would clearly provide very different binding properties in the very different environments where they will bind two items. Likewise, as in the airline example above, reward systems can be invented to use systems, software and reward mechanisms which efficiently optimize the repeat purchase rates between of buyers and sellers within very specific selling environments.

One environment with an increasing need for effective rewards for repeat sales between a buyer and a seller is retail selling on the Internet. The Internet selling environment is generally characterized by a relatively large number of sellers offering similar products to a geographically dispersed buyer base. The internet retail environment can also be described as commodity-driven since the same item may be available from hundreds or even thousands of sellers at the same time. Since a buyer's sought-after item is often virtually identical between multiple sellers across the internet, the main differentiator for the sought-after item most often becomes price. Book sales on the Internet provide a concrete example of this internet retailing environment. A new best-selling book could be available from hundreds or thousands of book sellers on the internet at the same time. These sellers generally ship a book through the same shipping infrastructure (USPS, UPS or FedEx in the USA). Thus, in this internet retailing environment, the book itself becomes a commodity item for retailing and shoppers can search across thousands of web-sellers in a matter of minutes using a search engine to find the lowest delivered price for the book. Price becomes the primary differentiator. Price differentiation is not optimal for a seller since a lower price reduces, or eliminates, profit.

The Internet shopping environment can further be defined by the frequency a buyer shops with various sellers. Buyers might purchase from a seller for one book today, a second seller tomorrow for a different book, a third seller the next day for a third book and so on. This flexibility to shop across sellers is a benefit to the buyer, but also restricts the buyer's ability to gain efficiencies in pricing via discounts by committing to multiple purchases with one seller. In the internet retailing environment, without a rewards program, sellers substantially lose the advantage they might hold if a buyer has purchased from them in the past. To offset this substantial loss of advantage, sellers can offer a buyer lower prices across multiple purchases since the seller gets a higher total dollar profit across multiple sales versus a lower dollar profit across one sale and the seller also retains the buyer. However, without a commitment or the knowledge that a buyer will return to make additional purchases, the seller will not offer discounts to the buyer. This creates an inefficient economic situation for both buyer and seller. Buyers want lower prices and might wish to make repeat purchases to get even lower effective prices, but the seller is best served by only offering discounts if the seller is assured of a repeat purchase. Providing buyers with a reward based on buyer consideration of a future sales (e.g. agreement to opt-in to receive emails) along with discounts contingent on a buyer payment for a purchase provides for a proportional benefit from the seller for the buyer's value to the seller. Providing a varying discounts for buyers based on purchase behavior allows for even further efficiency sought by both buyer and seller. A seller can offer a buyer a special discount schedule where subsequent purchases are offered a deeper discount if made in a period of time. However, the seller needs a system to track each subsequent purchase and a method and system to provide the discount to the buyer in a cost efficient way. Likewise, if a seller provides a standard reward in the form of a discount, the buyer needs a system where the discount is calculated automatically for the buyer; thereby reducing buyer engagement costs. Moreover, the buyer needs to clearly understand and be reminded of the subsequent reward for future purchase to properly consider whether a promised future reward will be valuable enough to purchase from the seller again.

Another critical element of all rewards programs including those on the internet is the process of reward redemption. Buyers are best served when rewards are instantaneous at the POS versus waiting for rebates to be delivered at a future time. Reward redemption processes can greatly affect the participation rate of buyers in a reward program. Reward redemptions using coupon codes at check-out are generally much more favorable to buyers because the buyer receives her reward instantly in the form of a discount off the purchase price of the item. Reward redemptions using rebates are generally much more favorable to the seller because the seller receives 100% of the buyer's cash before having to rebate the buyer any portion of the received cash.

Moreover, the internet retailing environment is characterieed by the seller possibly selling on multiple different web sites across the internet. For instance, a seller may list items for sale at eBay.com, Overstock.com, Amazon.com as well as on the seller's own e-commerce web site, all at the same time. The seller is attempting to maximize his/her ability to reach the buyer at any of these web locations. Unfortunately, when a seller sells across multiple internet sites, he/she generally loses the ability to track and retain a buyer across these sites since buyers on different sites use different user-names. For instance, when registering for a site like eBay.com buyers are forced to create a pseudonym. On a seller's own web-site the buyer may simply register with their name.

Internet retail sales are also characterized by the use of payment transfer agent services such as PayPal, GreenZap, BiRPay Google Wallet and others. These payment transfer agent services can often be used on different internet retail sites for purchases paid for by a buyer. Thus, a buyer with various different registered names across many internet retail sites might still use one registered identifying name for all purchases when paying through a single payment transfer agent. This unique characterization of the internet retailing environment means that a buyer's various different web-site registered names can often be tracked through the buyer's single payment transfer agent account. Likewise, a seller with multiple internet selling locations (e.g. eBay, Overstock, Amazon and their own e-commerce site) can track a single buyer making purchases from the seller on any of these sites for rewards by tracking the buyer's single payment transfer account identifier.

Internet retailers who utilize a payment transfer agent create the opportunity for more efficient reward redemption through the payment transfer service. Individual market venues and individual ecommerce web-sites often use different ecommerce platform software such as SAP, MarketWorks, ChannelAdvisor and the like. These utilize unique check-out processes which make automated redemption of rewards difficult, complex and expensive except for that platform. Different ecommerce platform software use many different versions of software called shopping carts. These shopping cart programs track the buyer's intended purchase(s) and facilitate the check-out process by consolidating intended item purchases into one transaction. An ecommerce site using one of these shopping carts can interface with the payment transfer agent to process the buyer's payment for the consolidated purchase(s) from the buyer's account housed with the payment transfer agent. Reward redemption at the point-of-sale in an environment with many unique ecommerce platform software programs or across multiple market venues would require interfacing with a multitude of shopping cart programs and tracking reward redemption across as many different ecommerce web-sites or market venues as utilize the reward system. On the other hand, utilizing the payment transfer agent for the reward redemption process provides a single point of interface for reward redemption across any website or market venue which interfaces with the payment transfer agent and allows for instant reward redemption.

One important aspect of internet purchases paid for from a payment transfer account is the potential use of coupon codes, also called redemption codes or gift certificates, at the point of buyer payment. The payment transfer agent can provide for the buyer's use of a coupon code at payment regardless of the ecommerce web-site or market venue engaged in the transaction. Thus, both individual web-sites can provide for the use of a site's own coupon codes at check-out using their own ecommerce platform software or shopping cart check-out process, while at the same time payment transfer agents can provide for the use of coupon or redemption code use at payment. Coupon codes are unique codes which are entered into a buyer entry field during check-out and/or payment. The buyer generally enters a specific string of characters into the provided coupon field to signny the coupon code. The check-out process and/or payment transfer agent accepts the coupon code, validates the coupon code and then calculates a final price the buyer must pay after the use of the coupon code based on a formula defined with the coupon. It is this net-of-coupon price which is actually paid by the buyer. For instance, if a buyer purchases an item that is fully priced at $100.00 and enters a coupon code which represents a 2% discount during check-out or payment, the buyer's final payment will represent only $98.00 as the check-out or payment transfer agent system will recognize the valid coupon and ultimately cause the buyer's account to be debited by the net-of-coupon price which is $98.00. Thus, the use of the payment transfer agent coupon codes in a reward program provides for immediate value to the buyer, in a highly efficient method independent of a specific ecommerce web-site or shopping cart software.

The internet retail environment is further defined by the fact that many buyers use different email addresses as a way to screen and categorize various possible inbound emails from web retailers. For instance, a buyer may have one email account for use at work which receives only work related emails. The same buyer may have a separate email which receives emails from family and friends. The same buyer may have several additional email accounts to receive emails relating to specific interests like college alumni emails, sports related emails, hobby-related emails etc. Some of these email addresses are more important to the buyer than others. The importance of an email address is often related to how frequently a buyer will check and review the email account for email communications. For instance, a work related email account might be reviewed by the buyer once an hour. Whereas an email account for a hobby or alma-mater might only be reviewed once per week. Because of the importance of the email account associated with a payment transfer agent, it can be assumed that the buyer will more frequently read and respond to emails sent to the buyer's payment transfer associated email address. This is an important consideration for sellers who wish to reach buyers with promotional emails within the context of a reward program. Sellers will be more successful if emails sent are reviewed with more frequency than other email accounts. It is therefore beneficial for a seller to reach a buyer in an email account with as high a priority as possible. By creating a reward program using the buyer's email account associated with the payment transfer agent, the seller has a significantly higher probability of getting the email read and acted upon.

In almost every payment option on the internet, the buyer provides the payment processor or payment transfer agent with the buyer's email address so the buyer can receive information from the payment processor or transfer agent relating to his/her account. In some instances, such as with PayPal, the buyer's email address is the payment transfer account identifier. The access and knowledge of the buyer's email address associated with the payment processor or transfer agent provides for a direct communication link to the buyer from the seller via email marketing.

Internet retailing is also defined by the opportunity to market to buyers via email promotions. Email marketing is a low cost method of promoting a seller's items to a buyer. Email marketing within the internet retail environment has evolved such that a seller is required by law or by common practice to request a buyer's permission to send emails to the buyer. This is known as opt-in permission. Generally, buyers provide opt-in permission at a very low rate, except in the case where the buyer is receiving some form of compensation for granting opt-in permission. MyStoreCredit.com claims that the industry average for opt-in permission without offering compensatory incentives averages 1-4%, while MyStoreCredit's Reward program offers a compensatory reward to buyers for granting opt-in permission through the form of a future store credit. MyStoreCredit claims it sees an average 17.5-19% email opt-in rate when a reward is offered with the opt-in. Thus, providing some initial form of reward to a buyer for opt-ing-in to a seller's email marketing program as part of a reward system has proven to be highly efficient.

The value of an email address is measured by the number of emails that can be sent to the buyer during the life of the loyalty service. If there is a “expiration” date for a reward in the reward program highlighted in each email, the value of the email address is only relevant until the expiration. Sending an email after a reward offer has expired would be an intrusion on the buyer. Likewise, creating coupon codes which have a pre-determined expiration date, provides an incentive for the buyer to purchase before expiration.

Internet retailing can also be characterized by the speed and automation expected by buyers and sellers. This is important because in the internet retail context buyers will not tolerate being required to mail in coupons or having to wait long time periods to receive promised loyalty benefits offered by internet retailers. In a traditional retail reward program, buyers often must mail in rebate forms or receipts. Buyers joining an internet reward program expect to have automated processes such that the buyer does not have to be engaged in mailing forms or otherwise executing significant activities to receive his/her promised loyalty reward. The time expectations for rewards are also very different for an internet retailing model. Time expectations are measured through instant rewards versus accumulating rewards for traditional retail reward programs. This time element is critical to the internet retailing environment. A buyer in an internet retail environment has come to expect nearly instant response to their actions. For instance, they will not tolerate check-out procedures that take longer then a few seconds as evidenced by Amazon's one-click check-out procedure and patent. Thus, an internet retail reward program providing immediate rewards at purchase is preferred by buyers.

Finally, internet retailing can often be characterized by sellers who operate on low margins. Because of the price-driven environment explained earlier, the internet seller often operates on extremely low margins. eBay.com has published analysis which shows that items for sale on eBay are generally 30% below the price for similar items at other ecommerce sites. Overstock.com and Amazon.com both publicly inform investors that their strategies are to offer items at cut-rate prices. Such aggressive retail pricing limits gross margin dollars available to fund any overhead expense such as a reward program. Moreover, it is likely that the internet retailer, and especially the smaller internet retailers, will not have the financial resources to staff and operate his/her own reward program. Nor do these internet sellers have the financial resources to pay overhead or fixed expenses for a reward program. The seller's financial constraints favor a pay-for-performance driven and variable expense reward program. Thus, a reward program optimized for the internet would be best implemented if it incurred variable cost driven by providing rewards commensurate with the spending made by the buyer. In this environment, it is critical that any reward program operate with a minimum of overhead expense, be primarily variable cost and require virtually no additional headcount or infrastructure to operate for an internet seller and be progressive or proportional so a seller incurs better rewards based on additional buyer purchases. Such a reward program would also pay-out rewards and incur costs for the seller upon transactions executed by a buyer.

### OBJECTS AND ADVANTAGES

Accordingly, several objects and advantages of my invention are providing any number, or type, of internet seller with a simple, readily understandable reward method and system where the seller uses the system to offer, track and reward buyer participation in the seller's reward program using coupon codes associate with a payment transfer agent service all independent of specific ecommerce platform software or market venue. The buyer's rewards are issued when a buyer opts-in to a seller's reward program and when the buyer makes subsequent purchases from the offering seller. Rewards are processed through the use of coupon codes valid only with the named payment transfer agent. The use of offered opt-in coupon codes is valid only when a buyer pays for a purchase with a valid account at the named payment transfer agent, said coupon code presented to the buyer prior to the buyer making payment in conjunction with a specific request to join the seller's email marketing list. The instant nature of the discount provided at the point of payment for opt-ing-in to an email list is prized by the buyer. The validity of the coupon code for use only when paying with the payment transfer agent named requires the system to interface with only one process irregardless of the seller's choice of ecommerce software or market venue. The system avoids the onerous and expensive interfaces required if the reward system interfaced with processes for many ecommerce software platforms or market venues which might be used by a multitude of sellers. The offered discount coupon code is applied when the buyer pays with her account at the specific payment transfer agent named at the time the coupon is offered. The rewarded coupon is processed by the payment transfer agent which calculates the reward at the point of payment such that the payment transfer agent debits the buyer's account only for the net-of-coupon amount, thereby efficiently providing for the fulfillment of the buyer's reward at payment check-out. The use of the offered opt-in coupon code entered by the buyer at payment for an initial sale also acts as the buyer's agreement to opt-in to receive subsequent emails from the seller. The instant discount coupon code offered as a reward is valid only with the payment transfer agent and provides a valued incentive for the buyer to agree to opt-in. Further, once the buyer is rewarded for opt-ing-in by using the offered coupon code, subsequent coupon codes can be generated and emailed to the buyer which provide additional discounts on additional purchases for the buyer whenever the buyer makes payment using the subsequent coupon code offered and the buyer pays with the same buyer payment transfer account utilized in the initial opt-in reward transaction. The buyer's participation in the reward program is based on the buyer's payment transfer account identifier rather than the buyer's identifying name or other ID as may be recorded at an internet market venue or ecommerce site. In the preferred embodiment, the payment transfer account identifier also provides for the buyer's email address. Thus, by keying on the payment transfer account identifier, the system can capture and use the buyer's email address for subsequent email promotions. Because of the association with the payment transfer account, the utilized email identifier account is likely to be a high-priority email account and thus any emails associated with the reward program will have a better chance of being read and responded to than if other email accounts are used for the buyer.

The use of the payment transfer agent is central to the invention because it also allows for the immediate and efficient provision of rewards for buyer activity with low buyer engagement. Specifically, when a payment is made by the buyer using the payment transfer agent, the coupon code can be described within the payment transfer agent system to apply a specific set of calculations to the payment price. This process utilizes the payment transfer system's capabilities rather than utilizing the reward system's own calculation and operating processes. By utilizing the payment transfer agents system to validate, calculate and process the offered reward, the reward system provides rewards to buyers immediately at payment. The reward system is designed for use by sellers such that required software and operations are centralized on the system and requires only seller internet access through a browser. The system also operates independently of the seller's other software programs and will not require additional overhead expenses at the seller location. The elements of the reward program are designed to be a variable cost for the seller since rewards are incurred based on buyer activity meaning sellers incur expenses commensurate with the buyer's transaction activity.

### SUMMARY OF THE INVENTION

The preferred embodiments of the present invention provide a system and method for enabling an auction or fixed-price seller, referred to herein as “seller,” to operate a reward program which rewards buyers for opt-ing-in to the offering seller's email list and for subsequent purchases using coupon codes valid with a specific payment transfer agent. Reward fulfillment occurs through the use of said coupon codes valid at a named payment transfer agent whenever the buyer pays for seller's items using the buyer's payment transfer agent account and when the buyer enters the offered coupon code at payment. The reward program also includes the creation and sending of email marketing messages to the buyer's email address associated with the payment transfer agent after use of the coupon code.

The reward system includes software and systems for a seller to establish her account within a seller database on the reward system using account creation software. During registration, the seller enters basic information signifying agreement to utilize the rewards system which may include identifying the seller by name, contact information, password, etc. The seller also enrolls one or more of her active seller accounts at the named payment transfer agent which the seller wants associated with the seller ID entered. When the seller completes registration, the reward system assigns an opt-in coupon code which is uniquely associated with that specific registered seller's payment transfer agent account(s). The seller-unique opt-in coupon code for the associated account(s) is created at registration or is preexisting and housed within a database within the reward system or payment transfer agent system and is assigned to the registered seller account. Immediately following registration, the system interfaces with the named payment transfer agent to associate the seller's unique opt-in coupon code with the registered active seller account(s) and to activate said opt-in coupon code.

In the preferred embodiment of the system, the opt-in coupon code represents a defined coupon code calculation which is subsequently used by the payment transfer agent system to reward all buyers who enter the associated active valid opt-in coupon code during payment with a discount. For instance, the formula associated with the unique activated opt-in coupon can be defined at the payment transfer agent system such that the payment transfer agent calculates an instant reduction of buyer payment by a fixed percent, say 2%, up to a specific amount, say $10.00, from the full payment due amount or fill payment due amount less shipping and handling, at such time as an activated opt-in coupon is entered by the buyer at payment. Thus, if a buyer makes a purchase from the associated seller and selects to pay with the specific payment transfer agent, the buyer can enter the coupon code in the payment check-out process. If the expected total payment for the purchase is $600, the buyer's payment transfer agent account is debited for only $590.00 since 2% of $600 is $12, but the maximum coupon value is $10.00. Alternatively, the opt-in. coupon code can represent a fixed price reduction of a dollar amount off the full price or full price less shipping and handling such as 2.00 off the payment. When the opt-in coupon code represents a fixed dollar amount, as in the example given, the buyer's payment transfer agent account would be debited by an amount less the dollar coupon value. In the example cited, the buyer's payment transfer account would be debited $598 after use of the offered $2.00 off opt-in coupon.

Next during registration the system creates a unique image for the seller. The image is a computer graphic image or specific text which is used by the reward system to present the reward program and the offered coupon code to potential buyers during the buyer's internet shopping or payment experience. The image discloses to potential buyers who are shopping or paying for the seller's item, exactly how the seller's reward program operates and what rewards can be obtained. Upon a buyer's browser opening the web page location where the image is presented, the buyer can read the reward offer in the image as displayed within the presented web-page. In the preferred embodiment, the web page is a seller's item selling page on a market venue such as eBay.com, Yahoo stores, Overstock.com or can also be a seller's item selling page on their own ecommerce store site. The seller causes the presented image to be displayed by either placing the image within the target web page themselves, or by authorizing the reward system or payment transfer agent system to present the image on a targeted selling or payment web page. Alternatively, the image can be presented within an HTML enabled email from within a web-enabled email reader.

The language in the presented image instructs the buyer to enter the offered opt-in coupon code while paying for the buyer's purchase using the named payment transfer agent, in order to receive an immediate discount for opt-ing-in to the seller's reward program and email list. The instructions make it clear that the buyer is receiving the offered reward in return for the buyer's express agreement to opt-in to the seller's reward program and for expressly opt-ing-in to the seller's email list.

To receive the reward, as instructed in the image, the buyer copies the seller's unique activated opt-in coupon code into the field provided during payment when payment is made by the buyer using the named payment transfer agent.

Upon entering the coupon code and completing the payment process, the payment transfer agent executes its processes such that the buyer's payment transfer agent account is debited for the expected cost of the items less the reward defined by the coupon code.

The payment transfer agent creates a record of the transaction associated with the completed payment transaction which used the opt-in coupon code. In the preferred embodiment of the invention, the reward system captures the transaction information from the payment transfer agent system by receiving relevant transaction information in an electronic message delivered to the reward system by the payment transfer agent system over a network such as the internet. Alternatively, the system can poll a specified account at the payment transfer agent web site to acquire the relevant transaction information for the coupon transaction.

The system captures the relevant transaction information in order to update various databases within the reward system. A buyer record is created in the buyer database. The buyer record lists the buyer payment transfer agent email ID. Within the buyer record a seller entry is created or an existing seller account is cross-referenced to the buyer. The seller fields record the seller ID associated with the utilized coupon code, the date, time, and rewarded amount for the transaction which used the opt-in coupon code and a positive indicator for email opt-in permission specific to that seller. The system next creates a unique subsequent coupon code which is associated as valid only for purchases between with the associated buyer and seller in the examined opt-in transaction. The validity associated with the combined buyer and seller means the subsequent coupon code cannot be used by the buyer when making a purchase using the buyer's payment transfer agent account from a seller other than the associated seller.

Next, the system creates and sends an opt-in confirmation email to the recorded buyer payment transfer agent email ID. The email is created using the system's email software. The email software system composes the email by marrying pre-determined text with the unique transaction information from the opted-in buyer transaction and sending it to the buyer payment transfer agent email ID. For example, the opt-in confirmation email may include a buyer a message welcoming the buyer to the seller's reward program buyer and then referencing the specific transaction where the buyer used the offered opt-in coupon code. The email content may confirm that the buyer has chosen to opt-in to the seller's email list in return for the discount rewarded through the opt-in coupon code. The email may also include the subsequent coupon code and text which explains the reward associated with the buyer's use of the subsequent coupon code. In the preferred embodiment of the invention the subsequent coupon code offers the buyer a subsequent coupon code which calculates a percentage discount as a reward for making subsequent purchases after opt-ing-in with the same seller. For instance, the subsequent coupon code can represent a 3% discount off the full payment price or 3% off the full payment price less shipping and handling. Alternatively, the subsequent coupon code can represent whatever the seller chooses to offer as a reward such as a fixed dollar amount or a varying percentage or dollar amount based on the full payment price of any transaction.

On a periodic basis, the system will also compose and send additional emails by marrying pre-determined text with the unique transaction and seller information and sending it to the buyer payment transfer agent email ID. For example, every 15 days following the sending of the opt-in confirmation email, the email software can create a marketing email for the buyer. These marketing emails may remind the buyer of the original purchase and of the availability of the existing subsequent coupon code and its associated reward. At the same time, the email software may add information about the seller's current item's available to purchase. Thus, the email communicates both the benefit of a second purchase along with suggested items to purchase. When composed, the system sends the email and repeats the process for additional marketing emails. Alternatively, the system can create a new subsequent coupon code after each purchase where each subsequent coupon code can expire in a set time frame or where each subsequent coupon code can increase in reward value for the buyer. For example, the first subsequent coupon code after an initial opt-in sale could offer a 3% discount value, while the next subsequent coupon code issued after the second purchase could offer a 4% discount value and the next subsequent coupon code could after the third repeat sale could offer a 5% discount value. Alternatively, the seller can establish a subsequent coupon campaign for emails sent in a given time period. For instance, a seller can offer a subsequent coupon code of 10% for any sales made within 21 days of the email delivery. The seller might also offer a subsequent coupon code of 25% off any purchase up to $50.00 for any buyer who has not made a purchase within the prior 200 days.

When a buyer returns to make a repeat purchase with the same seller, if the buyer chooses to pay for the item with the same payment transfer agent, the buyer can use the subsequent coupon code at the time of payment. As with the processing of the original opt-in coupon, when the buyer enters the subsequent coupon code at payment check-out the payment transfer agent executes its processes such that the buyer's payment transfer agent account is debited for the fill cost of the items less the reward defined by the subsequent coupon code.

As a normal course of business, the payment transfer agent creates a record of the transaction associated with the completed repeat payment transaction which used the subsequent coupon code. In the preferred embodiment of the invention, the reward system captures this information by receiving relevant transaction information in an electronic message sent by the payment transfer system to the reward system over a network. Alternatively, the reward system can poll a specified account at the payment transfer agent system to acquire the relevant transaction information for the subsequent coupon transaction.

The system captures the relevant subsequent coupon code repeat transaction information in order to update various databases within the system. The buyer record is updated in the buyer database. A seller transaction record is created or cross-referenced. The seller fields record the seller ID associated with the subsequent coupon code transaction, the date, time, and rewarded amount for the transaction which used the subsequent coupon.

At any time, a buyer may elect to opt-out of the seller's email list and reward program. The system provides a readily accessible opt-out process for opted-in buyers. Opted-in buyers may simply click an HTML opt-out link presented in emails sent to signify the buyer chooses to opt-out of the associated seller's reward program and email list. A buyer who clicks on this link in any email creates a message which is received by the system. Upon receipt, the system moves to immediately notify the payment transfer agent that the subsequent coupon code associated with the combined buyer and seller should be deactivated. Notification is sent via a properly formatted electronic message sent by the reward system to the payment transfer agent system. The reward system also calls the email software and a standard opt-out confirmation email is sent to the buyer. The reward system also marks the buyer's account as inactive for the seller record associated with the opt-out request and no future emails are ever sent to the buyer unless she chooses to opt-in again at a future date.

The system also has the functionality to send messages to the payment transfer agent to deactivate any or all an individual seller's unique opt-in or subsequent coupon codes upon certain events. For example, if the system records that a seller wishes to end her reward program, the system will accept the cancellation from the seller on a web-page form and will then immediately create and send an electronic message notifying the payment transfer agent system of the termination of the seller account and requesting the deactivation of the active coupon codes.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high-level architectural drawing illustrating the primary components of a seller reward system for buyer opt-in and purchase using coupon codes for purchases paid through a payment transfer agent.

FIG. 2 is a block flow diagram illustrating the method in accordance with the invention.

FIG. 3 is a diagram of information for a seller account record for use with one embodiment of the present invention FIGS. 4a-c are samples of the reward image as HTML code and in graphic form.

FIG. 5a-c are sample screen displays of selling pages and payment transaction page with the rewards image displayed.

FIG. 6 is a diagram of information for an available coupon code record for use with one embedment of the present invention.

FIG. 7 is a diagram of information for a buyer account record for use with one embodiment of the present invention.

FIG. 8 is a block flow diagram illustrating the marketing email creation method in accordance with the invention.

FIG. 9a-b are sample emails illustrating emails including coupon codes for use when paying through a payment transfer agent, created for use with the present invention.

FIG. 10 is a block flow diagram illustrating the buyer opt-out function in accordance with the invention.

FIG. 11 is a block flow diagram illustrating the deactivation of a seller account function in accordance with the invention.

FIG. 12 is a sample screen display of a create subsequent coupon campaign web page in accordance with the invention.

FIG. 13 is a sample screen display of a final payment page from a payment transfer agent reflecting the discount rewarded after submission of an opt-in reward coupon code by the buyer at payment.

### DETAILED DESCRIPTION OF THE PREFERRED EMBODIMENT

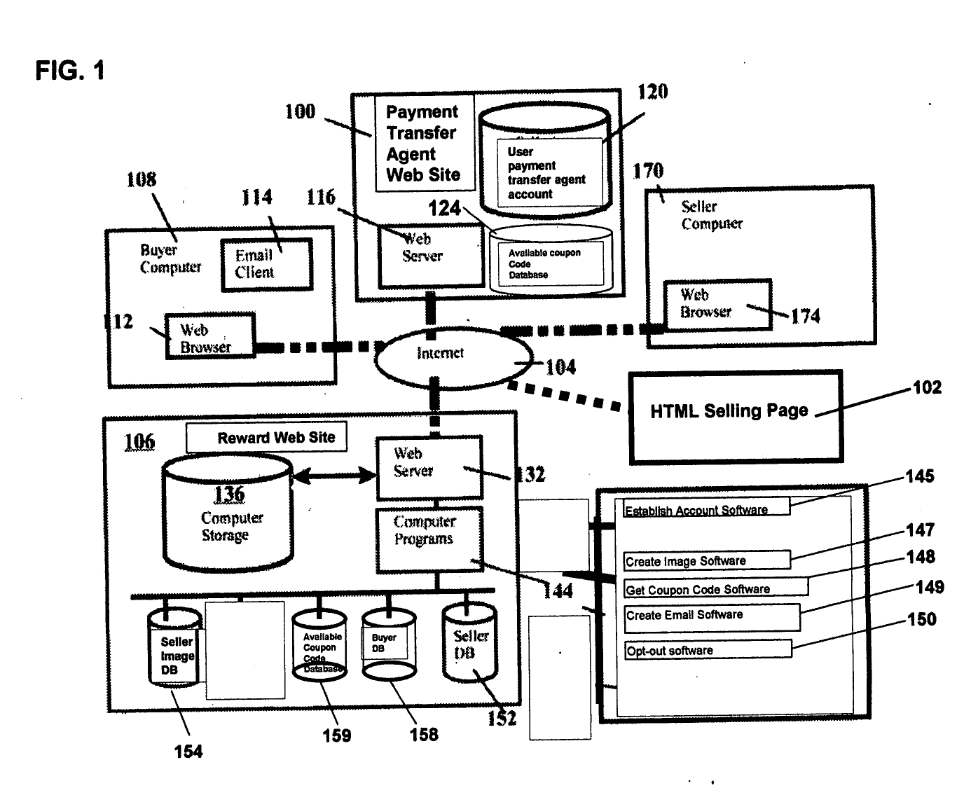

FIG. 1 is a high-level architectural drawing illustrating the primary components of a reward system used by sellers to reward buyers using coupon codes for purchases and opt-in when payment is made through a payment transfer agent. The reward system includes a buyer computer 108, a payment transfer agent web site 100, a seller computer 170, an HTML selling page 102 and a reward web site 106, all of which are linked together by the Internet 104.

The buyer computer 108 may be any type of computing device that allows the buyer to receive and respond to emails using a email client 114 and interactively browse Web sites via a Web browser 112. For example, the buyer computer 108 may be a personal computer (PC) that runs the Windows NT operating system and Netscape Navigator and which can access the Yahoo Mail email service at Yahoo.com.

The preferred embodiment of this invention is a system and method for use with the Internet 104, a widely known global computer network. This invention is, however, not limited to the Internet. Thus, as used herein, the term “network” refers to any distributed computer network whether it be a local area network (LAN), a wide area network (WAN), or an Intranet.

The payment transfer agent web site 100 is a web site such as PayPal.com, GreenZap.com, Google.com or JPMChase.com which provide functionality allowing buyers to pay participating sellers for items purchased from internet based sellers or to allow two parties to transfer money between each other. Typically, the payment transfer agent web site 100 will be operated by a business entity that handles buyer and seller account creation, payment transaction processing at the close of a sale including check clearinghouse functions such as debiting and crediting accounts of two or more parties as well as credit card payment processing and the validation and proper accounting for the use of coupon codes, discount codes, gift certificates, redemption codes or other similarly named codes. The payment transfer agent web site 100 includes a user payment transfer account database 120, a web server 116, and an available coupon code database 124.

The reward web site 106 advantageously includes a web server 132 and computer storage 136, a seller account database 152, a seller image database 154, a buyer database 158, an available coupon code database 159 and multiple computer software programs 144 (FIG. 1B)

The HTML selling page 102 is a document written in hyper-text mark-up language that can be created or read over the Internet using a web browser. In the preferred embodiment, the HTML selling page 102 promotes an item or service for sale and contains text, images and links within the selling page. Alternatively, the HTML selling page 102 can be an HTML email message or the HTML selling page 102 can be an HTML payment transaction check-out web page. The invention operates distinctly from any specific market venue such as Yahoo.com, eBay.com or ecommerce software platform which may have created the HTML selling page 102.

The seller computer 170 may be any type of computing device that allows the seller to interactively browse and create HTML selling pages and Web sites via a Web browser 174. For example, the seller computer 170 may be a personal computer (PC) that runs the Windows 2000 operating system running Internet Explorer.

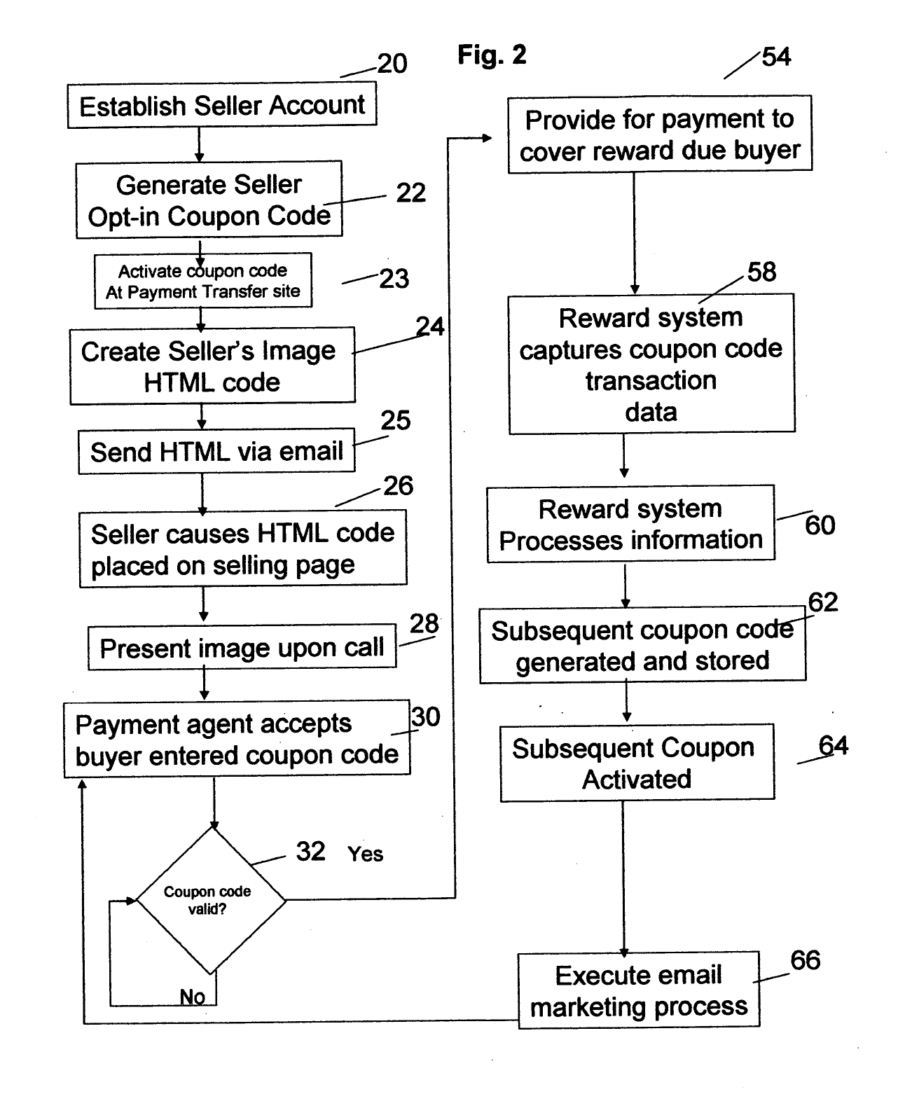

FIG. 2 is a general flow diagram of the method of this invention. Referring to this figure, establishment of a seller account is initiated at Step 20. Establishing a seller account includes the seller inputting seller account information to signify participation in the reward service as presented over the internet 104 to the seller's web browser 174 by the reward system 106 using the establish account software 145 in the computer programs 144. Such input information includes the seller's payment transfer agent account or accounts recorded in the user payment transfer account database 120 on the Payment Transfer Agent web site 100. The established seller account may also include the seller name, address, billing information, frequency of opt-in emails to be sent to opted-in buyers and information relating to the seller's selling venues (auction sites, web sites, store fronts, etc). This account information is entered by the seller into a seller unique database record housed on the reward system's seller database 152 on the reward web site 106 using the account registration software 145 within the computer programs 144.

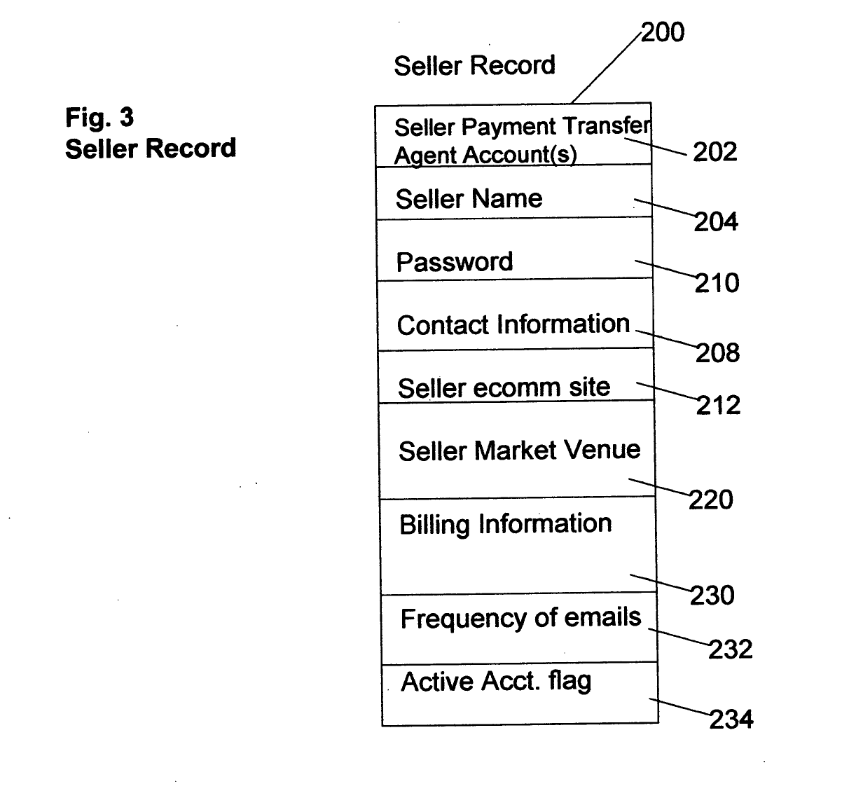

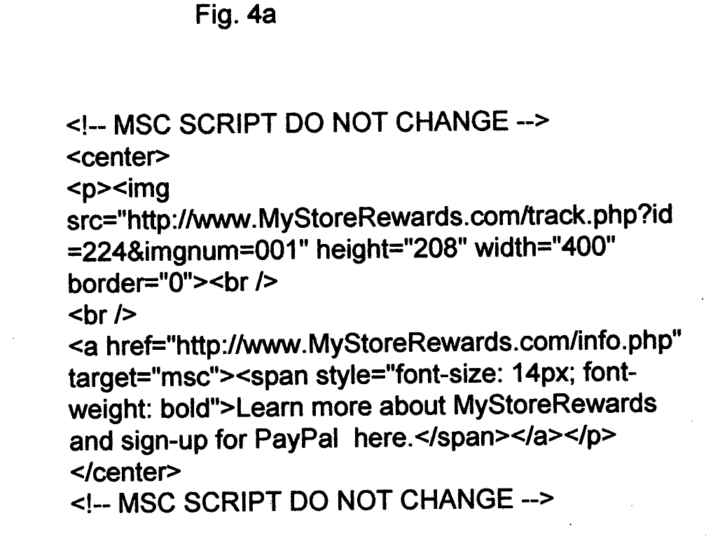

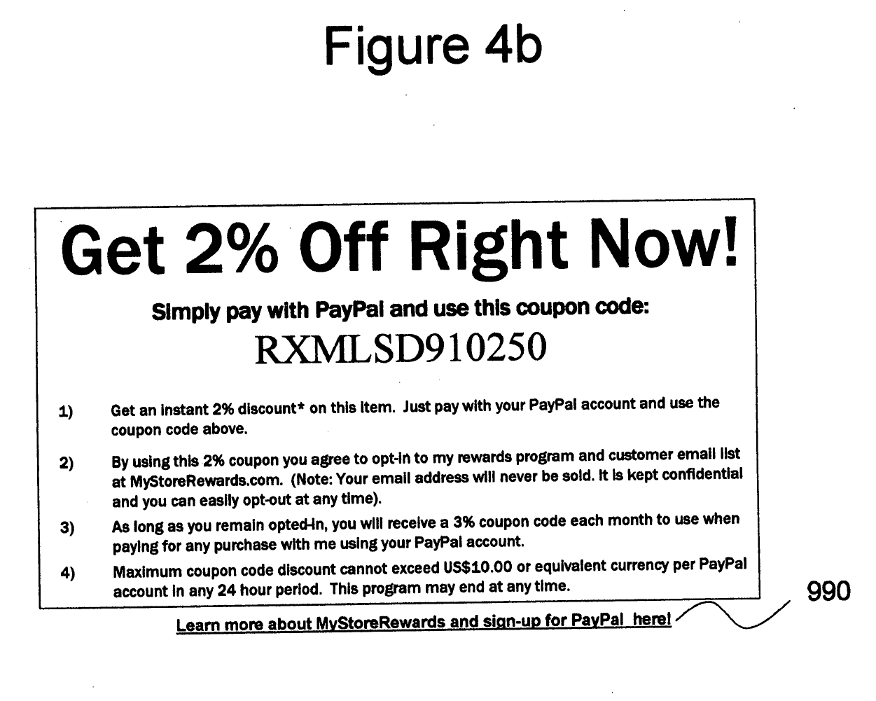

FIG. 3 is a diagram of information for a seller account record for use with one embodiment of the present invention. Referring to FIG. 3, the seller enters personal identifying information such as the seller payment transfer agent account or accounts 202 which the seller wishes to names. Further, the seller enters the seller's name 204, password 210 and other contact information 208. The seller also enters the seller ecommerce site 212 and seller market venue 220 in order to identify the location or locations where the HTML selling page 102 will be resident. Frequency of emails 232 is a selection made by the seller during registration to indicate the time period marketing emails are to be sent to buyers.

After a seller establishes an account, the invention next executes a generate seller opt-in coupon code, step 22, which will be used to reward buyers who choose to opt-in to the seller's reward program and email marketing list. The opt-in coupon code is generated by the reward system 106 by executing the get coupon code software 148 from the computer software 144 on the reward system 106. The get coupon code software 148, polls the payment transfer agent system 100 over the internet 104 to capture an available coupon code from the available coupon code database 124 on the payment transfer agent system 100. Alternatively, the get coupon code software 148 can create a string of randomly generated alphanumeric characters such as YLEKSBEOGKC or a string of fixed and randomly generated alphanumeric characters such as IOPTINYLEKSB to provide the opt-in coupon code for recording in the available coupon code database 124 on the payment transfer system 100. During this step 22, the available coupon code is stored on the reward system 106 within the available coupon code database 159.

After storing the coupon code on the reward system, during Step 23, the get coupon code software 148 will send a message over the internet 104 to the payment transfer agent 100 to cause the activation of the assigned seller's opt-in coupon code within the available coupon code database 124 on the payment transfer agent web site 100. Activation includes the capture by the payment transfer agent system of all information relating to the opt-in coupon code as recorded on the available coupon code database 159 on the reward system 106. In this way, both the reward system web site 106 and the payment transfer agent web site 100 will have a record of currently active opt-in coupon codes for use by the system. Moreover, after step 23, the payment transfer system 100 will be properly staged to validate and accept the generated opt-in coupon code whenever a buyer subsequently uses the opt-in coupon code for payment only with the assigned seller during a payment transaction using the payment transfer agent web site 100.

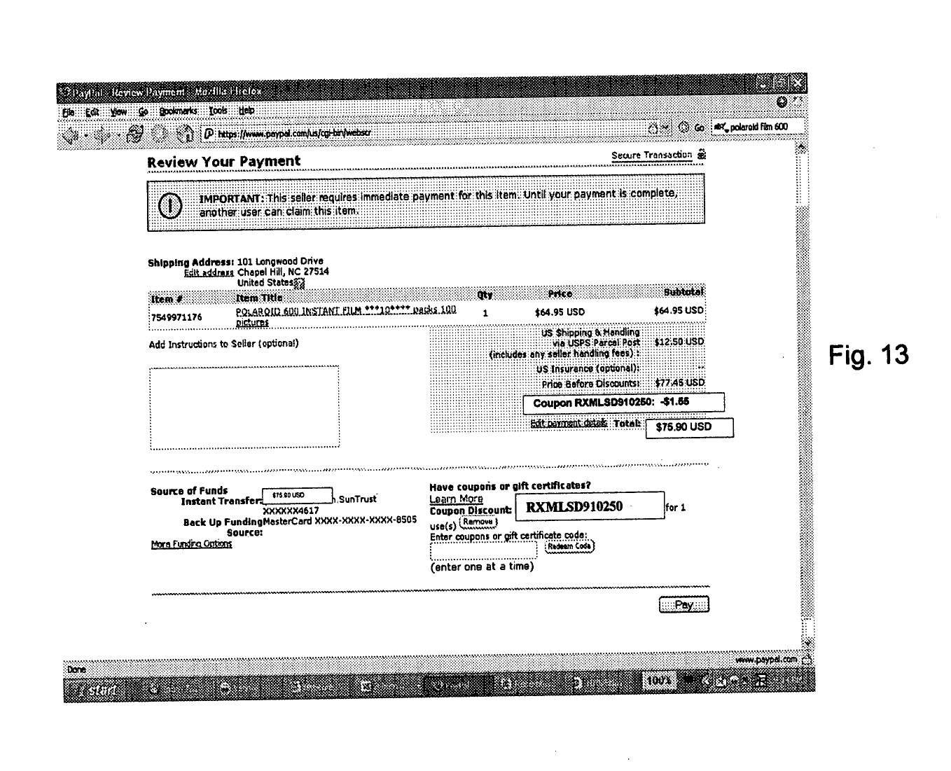

When activated and present within the active coupon code database 124 on the payment transfer system web site 100, the coupon represents a calculation which will provide all information required to provide a defined reward for the buyer who uses the opt-in coupon code during payment. FIG. 13 represents a sample payment transfer agent and buyer payment transaction showing the use of a coupon code by the buyer to receive a reward in the form of a discount of the buyer's payment amount.

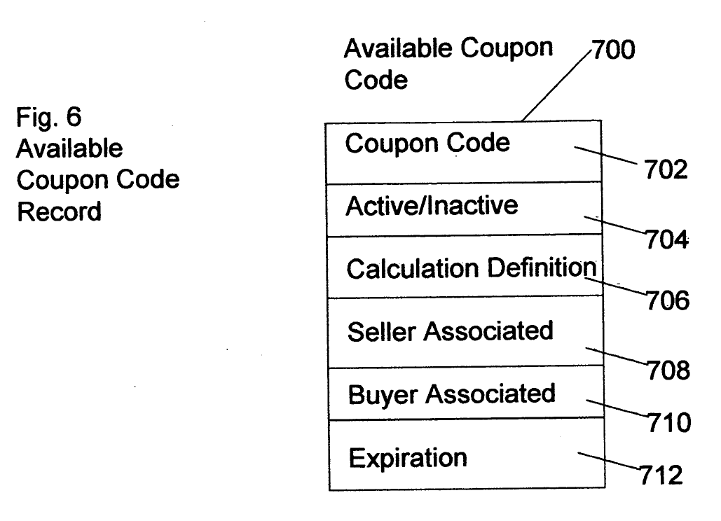

FIG. 6 is a diagram of information for a coupon code record for use with one embodiment of the present invention. Referring to FIG. 6, the field for coupon code 702 houses a unique alphanumeric character string that defines the coupon code record. The field for active 704 indicates whether the coupon code is active or not. An active code is available for use by a buyer. An inactive code is not valid for use by a buyer to receive a discount during a payment transaction. The field for calculation 706 represents the specific formula for calculating a discount when an active coupon code is used during a payment transaction. In the preferred embodiment of the invention, the calculation associated with the unique activated opt-in coupon code provides for an instant reduction of payment by the buyer of a fixed percent up to a specific amount from the full payment due amount or full payment due amount less shipping and handling, at such time as an activated opt-in coupon is entered by the buyer at payment. The payment transfer agent web-site 106 utilizes the calculation in determining how much to debit from the buyer's payment transfer agent account.

FIG. 13 represents a sample payment transfer agent and buyer payment transaction showing the use of a sample opt-in coupon code by the buyer to receive a 2% reward in the form of a discount of the buyer's payment amount.

Alternatively, coupon code calculation options can include a percentage discount off the total payment or off the total payment less shipping and handling with no limits. Or, the calculation can represent a fixed dollar discount. Other variables are expected to be used to represent the calculation of the coupon value in this field.

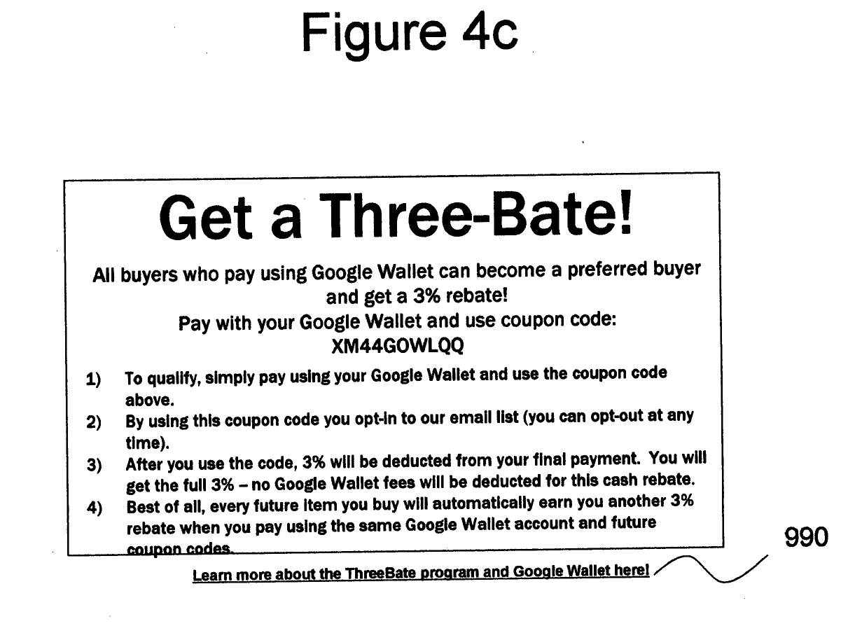

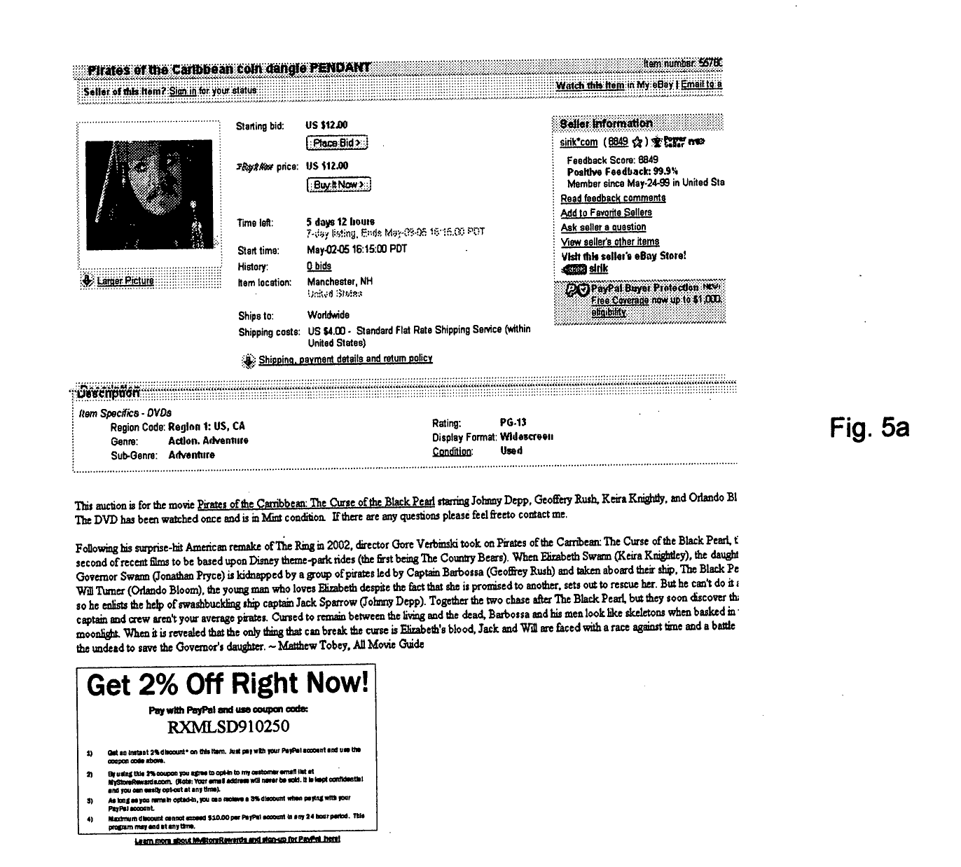

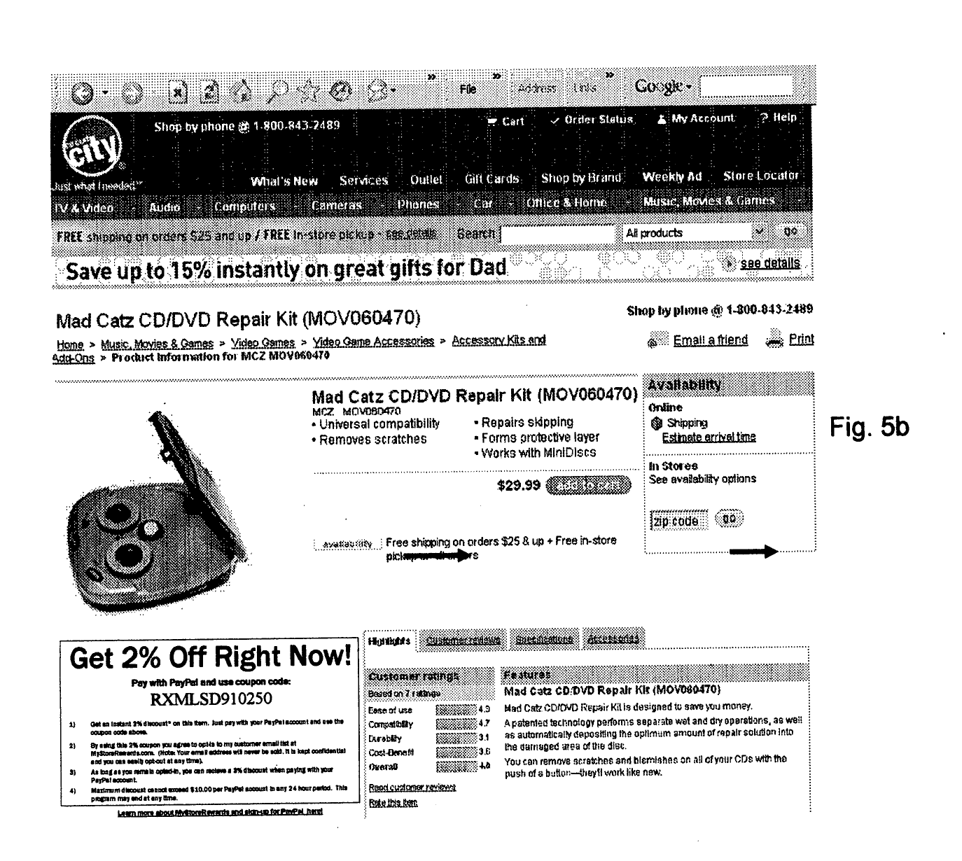

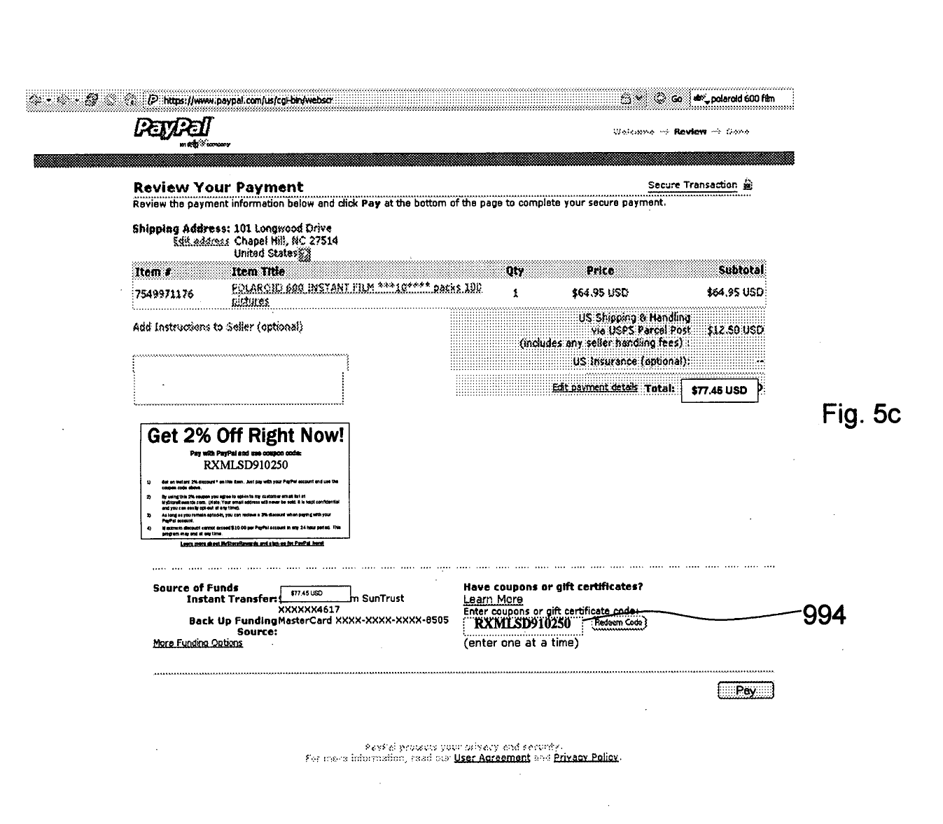

Returning to FIG. 6, the field for seller associated 708 represents the seller ID associated with the coupon code. The field for buyer associated 710 is left blank in the opt-in coupon code but is completed for other coupon codes. By leaving the field for buyer associated 710 blank for us with opt-in coupon codes, the payment transfer agent system 100 can validate the opt-in coupon code for all buyers to use for payment of a purchase from the associated seller as recorded in the associated seller field 708. The field for expiration 712 represents any possible date of expiration for the coupon code record. If the date for expiration arrives, the coupon code record is marked inactive in field 704 Next, at step 24, the system creates a unique image for the seller. In the preferred embodiment of the invention, the image file is an HTML graphic image used with the reward system by the seller to present the reward program to all potential buyers from within the seller's HTML selling page 102 at a market venue or on the seller's own ecommerce site or within an HTML email. Alternatively, the image can be presented to the buyer during payment check-out directly on the payment check-out pages presented by the payment transfer agent web server 116 during buyer payment check-out. FIG. 4a is a sample of the HTML code and FIG. 4b and c are screen displays of two different embodiments of he resulting sample image. FIG. 5a-b are screen displays of HTML selling pages 102 with the image included as viewed in a buyer web browser 112. FIG. 5c is a screen display of an HTML payment transaction check-out page with the image included as viewed in a buyer web browser 112.

As shown in FIG. 4b and 4c, the image file includes text which explains the reward for opting-in to the seller's reward program and email list. The image is in the form of a graphic file such as a JPG, GIF or PNG type graphic file which resides on the reward system's seller image database 154. The seller's unique image acts to inform the potential buyer of the unique opt-in coupon code associated with the seller. In the preferred embodiment, the image explains that if the buyer purchases the item co-located on the seller's HTML selling page 102 where the image is being presented (FIG. 5a-b), and the buyer also pays for the co-located item using the specific payment transfer agent web site 100 and the buyer enters the opt-in coupon code displayed in the image at the time of payment check-out, the buyer will automatically receive a discount up to a specific amount and will be automatically enrolled in the seller's reward program and opted-in to the seller's email list as explained in the image. The image includes a link 990 to find out more information about the reward program or to sign-up for a payment transfer agent account.

The combination of the presented image, its resident seller specific active coupon code and the use of the coupon code only with payment transactions made on the payment transfer agent system 100 is a critical element of the invention because the image can be easily placed by the seller on any item selling web page (FIG. 5a-b) on any ecommerce or market web site during web page creation, or within an HTML email or directly on the payment transaction check-out page (FIG. 5c) and the image efficiently discloses the reward program to the buyer with no extra hardware or software required by the seller. The image as described can be placed within any listing template or selling page on a market venue web site such as eBay.com, or on hosted store fronts, such as Yahoo Stores, or on an ecommerce site directly owned by the seller or within an HTML enabled email selling message.

Returning to the registration process, the HTML code is sent to the seller over the internet 104 as an attachment to a welcome email after the successful completion of the seller's registration, step 25. Sellers can also return to the reward web site 106 to retrieve the seller's HTML code at any time.

At step 26, the seller causes placement of the HTML code (FIG. 4a) on to any HTML selling page 102 (FIG. 5a-c). The seller can place the HTML code (FIG. 4a) on to a listing directly or alternatively the seller can cause an automated insertion of the HTML code.

In step 28, when a buyer web browser 112 is directed by a buyer to the HTML selling page 102 over the internet 104, the buyer's web browser 112 stimulates a call to the reward web site 106 over the internet 104 which provides the image from the seller image DB 154 through the system's web server 132 so the image (FIG. 4b-c) is presented at the place on the HTML selling page 102 chosen by the seller as shown for example in FIG. 5a-c. A graphic file is superior to simple text because it is substantially more difficult to tamper with the reward program disclosures presented within the image file than to tamper with an explanation in a pure text file although a string of text can be used as the image in one embodiment of the invention. Moreover, since the graphic image file resides on the reward web site 106, any required update or suspension of the seller's reward program can occur with one simple change at the reward web site 106.

At step 30, the buyer manually enters the coupon code and the payment transfer agent accepts the coupon code entered. In the preferred embodiment of the system, it is important to note that the image relays information disclosing that buyer reward requires payment be made by the buyer using the specific payment transfer agent 100 in the system. To receive the reward, as instructed in the image, the buyer copies the seller's activated opt-in coupon code into the field provided during payment (994, FIG. 5c) when payment is made by the buyer using the named payment transfer agent.

At step 32, the payment transfer agent validates the coupon code as active and associated with the seller and available for use by the buyer in the payment transaction by reviewing the active field 704 and the buyer associated field 710 for the coupon code entered and as recorded on the available coupon code database 124 on the payment transfer agent system 100. If the active field is active and the buyer associated field matches the buyer making the purchase or if the buyer associated field 710 is blanks the coupon is validated and the system moves to step 54. If not valid, the payment transfer agent returns the buyer to repeat step 30 to manually enter a valid opt-in coupon code.

At step 54, the Reward system provides for proper payment incorporating the reward amount earned by the buyer in step 30. Providing for the payment includes maintaining a user payment transfer agent account designated for the reward system within the user payment transfer agent account database 120 on the payment transfer agent system 100. At step 54, the payment transfer agent system 100 can properly processes the buyer's payment transaction by applying the formula for the offered coupon code to calculate the appropriate payment to debit from the buyer's user payment transfer agent account (FIG. 13) and to debit from he Reward System's user payment transfer agent account, both of which are records in the user payment transfer agent account database 120. The discount payment amount represented by the coupon code is debited from the reward system's user payment transfer account and the difference between the reward and the price owed to the seller is debited from the buyer's user payment transfer account. In this way, the payment system 100 can credit the fill amount of the purchase payment in the seller's user payment transfer account in the user payment transfer agent account database 120.

At step 58, the reward system 106 captures transaction information relating to the payment transaction utilizing the coupon code from the payment transfer agent system 100. In the preferred embodiment of the invention, the reward system captures the transaction information by receiving relevant transaction information in an electronic message delivered to the reward system by the payment transfer agent system over a network such as the internet 104. Alternatively, the system can poll the reward system's user payment transfer agent account record in the user payment transfer agent account database 120 on the payment transfer agent web site 100 to capture the relevant transaction information for the coupon transaction.

At step 60, the reward system processes the relevant transaction information in order to update various databases within the system. At this step, a buyer record 300 is created or updated in the buyer database 158 on the reward system 106.

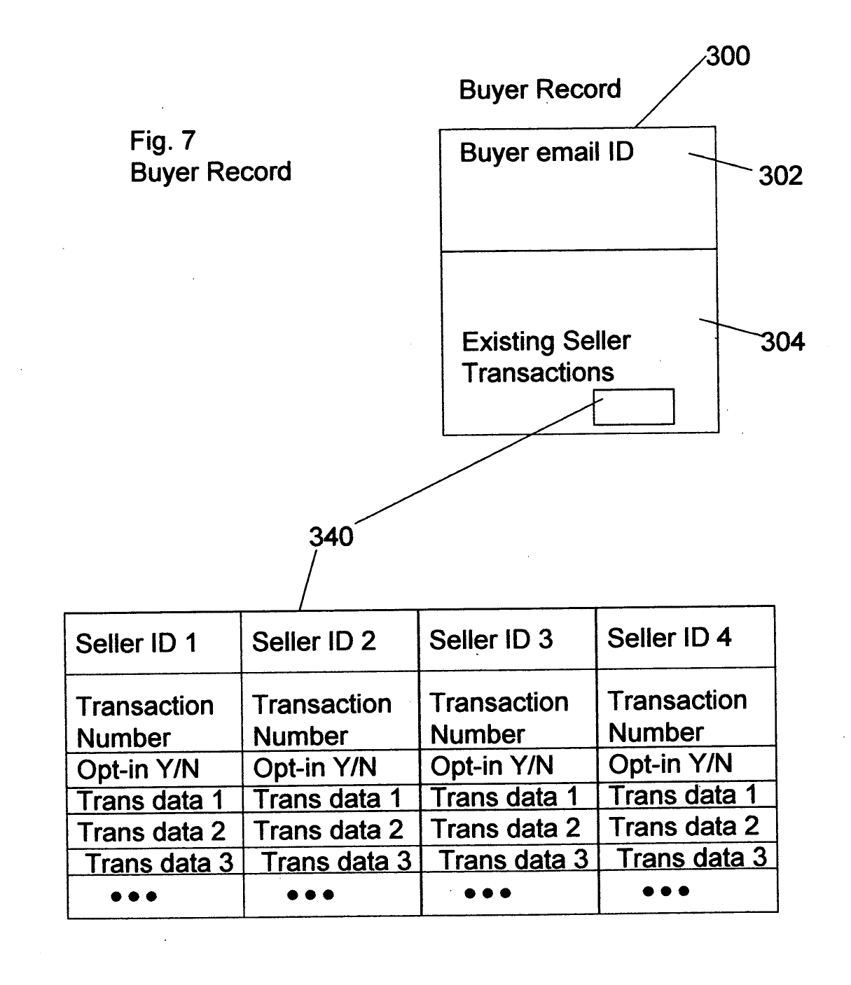

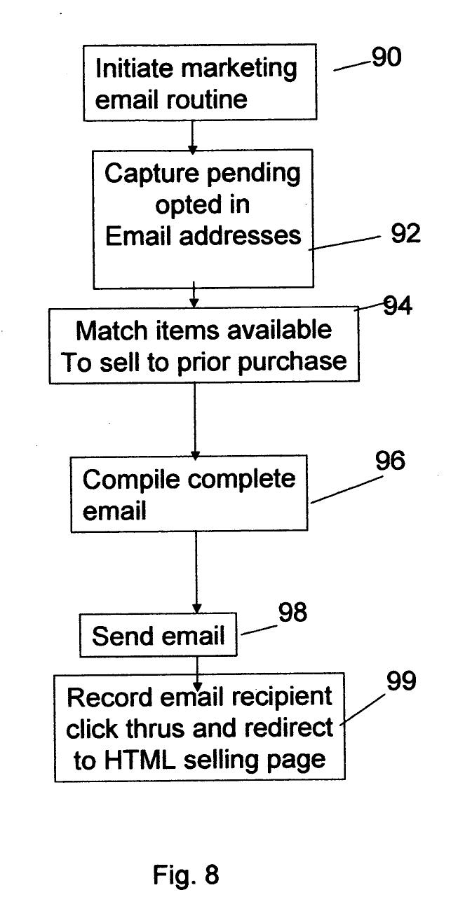

FIG. 7 is a diagram of information for a buyer record for use with one embodiment of the present invention. Referring to FIG. 7, information establishing a buyer email ID 302 is recorded from the information provided in the relevant transaction information. A seller transaction field 304 is recorded. The seller transaction field 304 includes transaction information 340. Information recorded with each transaction includes the seller ID, the transfer agent payment transaction number for the transaction, an opt-in signifier, and for any other relevant data for the transaction such as transaction time, date, total payment, etc. Each time a buyer transacts with the seller and uses a valid coupon code, the transaction information for each new transaction is recorded in the field for transaction information 340. The buyer email ID 302 houses a unique alphanumeric character string that defines buyer's opted-in email address.

After recording the transaction which used the opt-in code, at step 62, a subsequent coupon code for the buyer's use is generated and stored in the reward system. The subsequent coupon code will be used to reward buyers who choose to make subsequent purchases after opt-ing-in to a seller's reward program and email list. The subsequent coupon code is generated by the reward system 106 by executing the get coupon code software 148. The get coupon code software 148, polls the payment transfer agent system 100 over the internet 104 to capture an available coupon code from the available coupon code database 124 on the payment transfer agent system 100. Alternatively, the get coupon code software 148 can create a string of randomly generated alphanumeric characters such as YLEKSBEOGKC or a string of fixed and randomly generated alphanumeric characters such as NEXT3%EKSB to provide the subsequent coupon code for recording in the available coupon code database 124 on the payment transfer system 100 and within the available coupon code database 159 on the reward system 106.

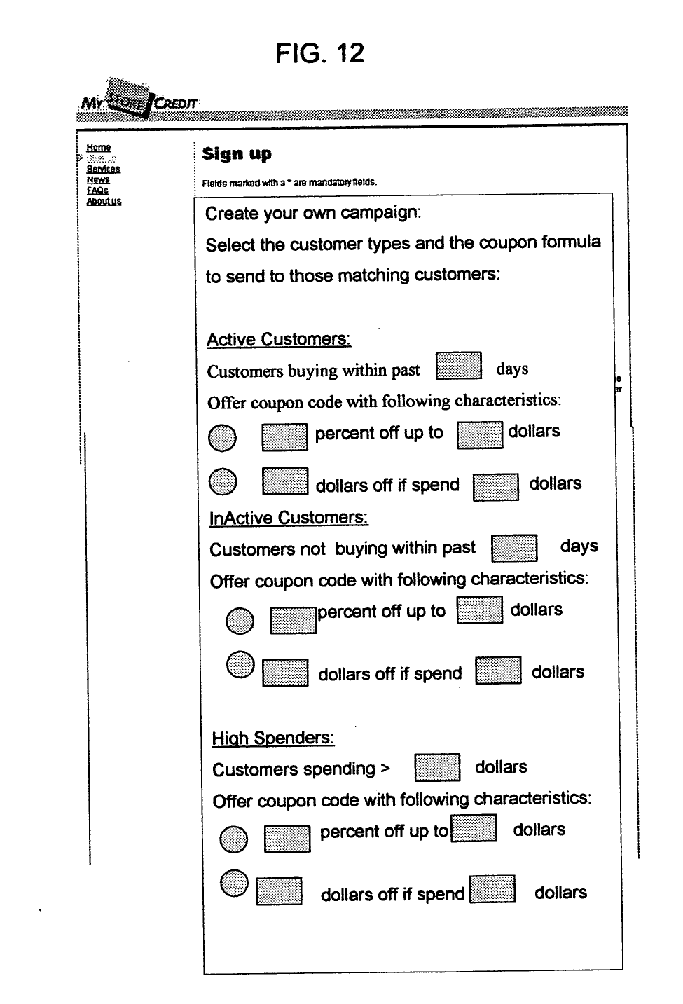

In step 62, the system could also vary the calculation which should be associated with a generated coupon code by creating a coupon code to match any seller input received during step 20, establish seller account. By accessing the establish account registration software 145 with a seller web browser 174, the seller can create a campaign by setting the formula for subsequent coupon codes which will be sent in emails to buyers who match the criteria of the created campaign. FIG. 12 is a sample screen-shot of potential input screens presented during establishing account or on updating an established account for a seller to define various coupon code formulas for various types of the seller's opted-in buyers.

Referring to FIG. 12, a seller can choose to define subsequent coupon code calculations by, for example, offering a specific percent off discount or dollar off discount to buyers who have been active or inactive for a specific period, or who spend a specific amount of money for purchases from the seller. Other formulas are anticipated and can be created as appropriate. The reward system 106 uses this seller input to create formulas for creating specific subsequent coupon codes and stores those coupon code formulas in the available coupon code database 159.

After also storing the subsequent coupon code on the reward system, during Step 62, the system moves to step 64. In step 64, the get coupon code software 148 will send a message over the internet 104 to the payment transfer agent 100 to cause the activation of the assigned seller's subsequent coupon code for use with the specific buyer email ID recorded in the buyer record 302 as recorded in the buyer associated field 710 in the available coupon code database within the available coupon code database 124 on the payment transfer agent web site 100. Activation includes the capture by the payment transfer agent web site 100 of all information relating to the coupon code as recorded on the available coupon code database 159 on the reward system 106. The subsequent coupon code is different from the opt-in coupon code because the field 710 in the subsequent coupon record 700 will include a buyer associated record. The payment transfer agent system 100 will validate any subsequent coupon code only if the evaluated subsequent coupon code is acvtive 704, unexpired 712 and being used for payment between the buyer ID recorded in the buyer associated field 710 and the seller associated field 708 for the coupon code entered.

When activated and present within the active coupon code database 124 on the payment transfer system web site 100, the subsequent coupon code represents a calculation which will provide all information required to provide a defined reward for the buyer who uses the opt-in coupon code during payment.

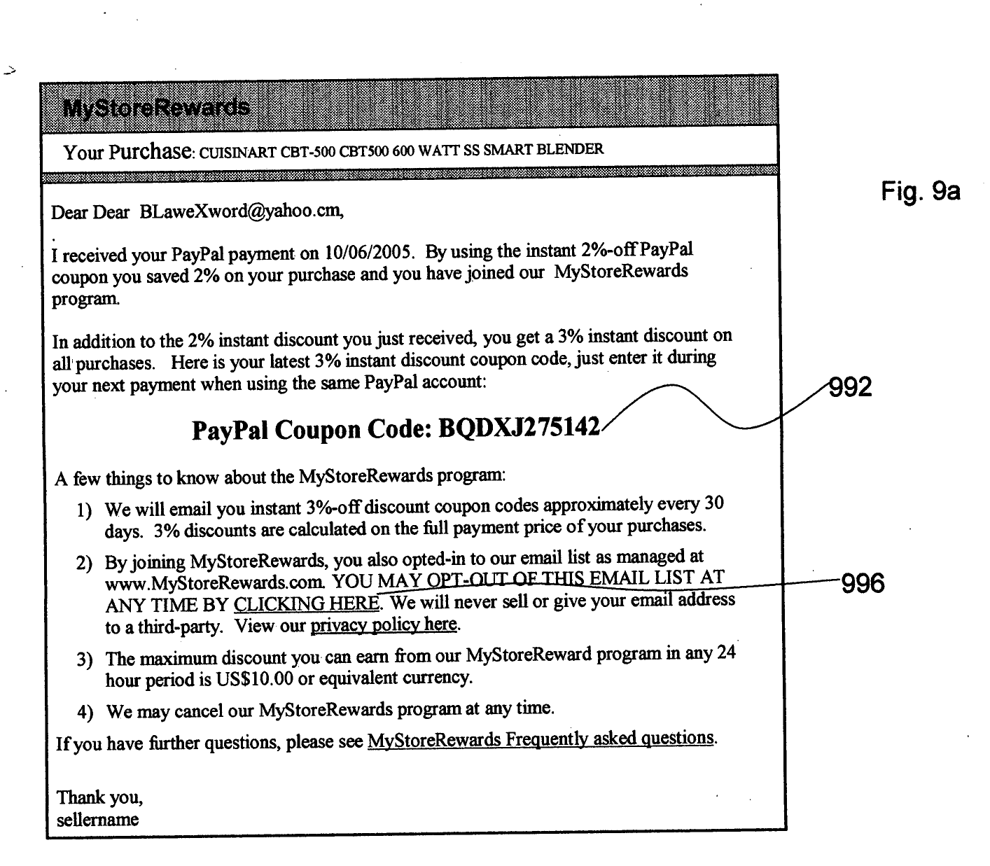

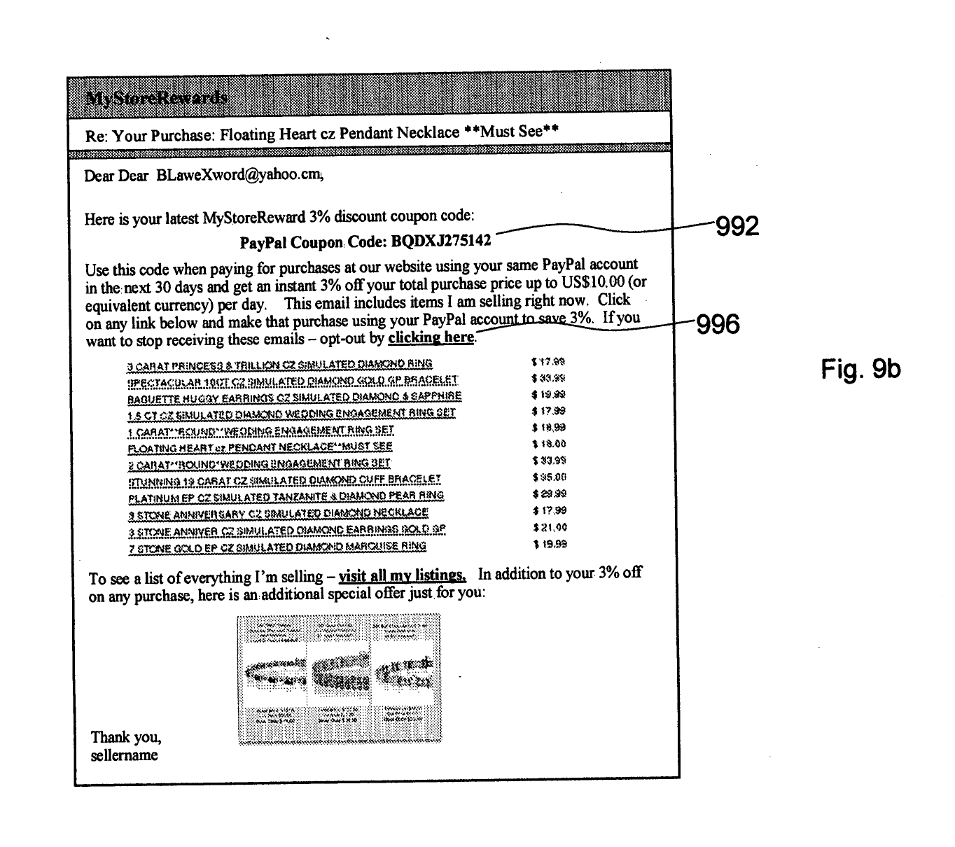

At step 66, the system moves to create and send emails with active buyer specific coupon codes available as a discount reward from the seller to the buyer when a subsequent purchase is made. To create and send email marketing messages, the reward system will call the create email software 149 to compose and send emails by marrying pre-determined text with the unique transaction and seller information and available active coupon codes to the buyer payment transfer agent email ID. These emails can be created immediately following opt-in. FIG. 9a represents an example of a marketing email sent after opt-in with the subsequent coupon code (992) embedded in the email.

Additionally, in the preferred embodiment of the invention, periodically such as every 30 days, the create email software 149 can create a marketing email for the buyer. These marketing emails will remind the buyer of the original purchase and of the availability of the unexpired subsequent coupon code and its associated reward. FIG. 9b is an example of an email which can be periodically sent to the opted-in buyer showing the subsequent coupon code (992). When composed, the system sends the email and repeats the process for additional marketing emails on the periodic basis.

The system next returns to step 30 after step 66 for the use of the subsequent coupon code by the buyer in the same manner as the opt-in coupon code is used by the buyer at step 30. The system continues to operate from step 30 for subsequent coupon code redemption through to step 66 for each instance of the subsequent coupon code usage by the same buyer. In this way, as each sale is paid for by an associated buyer using a coupon code the transaction information is captured and a new coupon code is created.

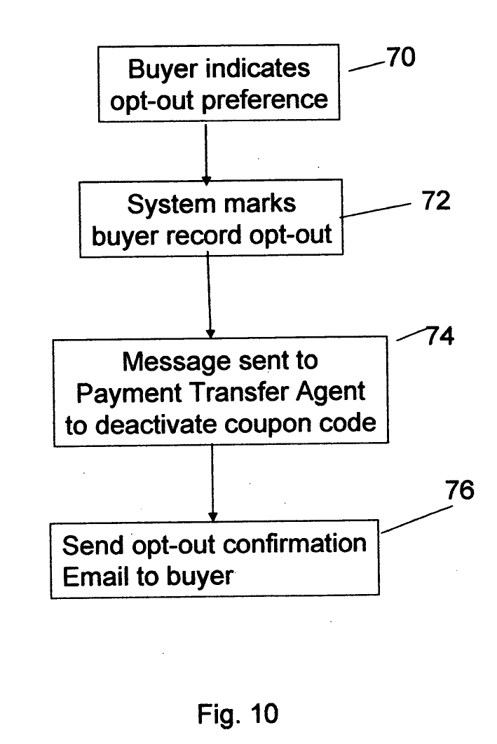

At any time, a buyer may elect to opt-out of the reward program. The system provides a readily accessible opt-out process for opted-in buyers. FIG. 10 represents a block flow diagram of the opt-out process. In step 70 an opted-in buyer indicates to the system a preference for opt-ing-out of the seller's reward program and email list. Opted-in buyers may simply click an IM opt-out link (996) presented in seller specific marketing emails (ig. 9a-b) using their email client 144 to signify that buyer's choice to opt-out of the associated seller's reward program and email list. Alternatively, the buyer can enter their opt-out preference on the reward system web site. In step 72, the system updates the buyer record database 300 for the buyer by switching the opt-in marker in the existing seller transaction 340 to signify opt-out for that seller. Next, at step 74, the reward system 106 sends an electronic message over the internet 104 to the payment transfer agent system 100 requesting deactivation of the unexpired subsequent coupon code associated with the buyer and associated seller. This steps prevents the opted-out buyer from receiving the reward by deactivating any available coupons. Finally, at step 76, the reward system also calls the email software 149 and a standard opt-out confirmation email is sent to the buyer email ID 302.

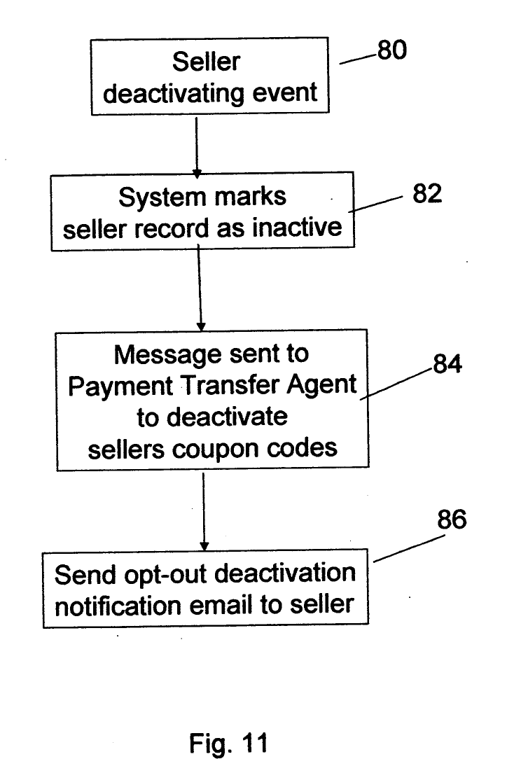

The system provides a deactivation process for seller accounts. FIG. 11 represents a block flow diagram of the seller deactivation process. In step 80 an event occurs to initiate seller deactivation. The event may be a seller choosing to end participation in the reward system by the seller updating the seller's record 200 using the establish account record software 145 through the seller's web browser. 174 over the internet 104. Alternatively, the system may deactivate a seller account automatically if the seller's user payment transfer account, residing within the user payment transfer agent account database 120 is closed or if the billing information 230 in the seller record 200 indicates an overdue payment. Upon identifying the deactivation event, step 80, the system moves to step 82 and updates the Active Account Flag field 234 in the seller record 200 to deactivate the seller. Next, at step 84, the reward system 106 sends an electronic message over the internet 104 to the payment transfer agent system 100 requesting deactivation of the unexpired coupon codes associated with the deactivating seller account. In this way, no buyer can use any seller associated coupon codes after a seller account is deactivated. Final@, at step 86, the reward system also calls the email software 149 and a standard deactivation notification email is sent to the seller email ID recorded in the seller contact information field 208 in the seller record 200.

It will be appreciated by those skilled in the art that numerous modifications and variations are possible, and that the invention may be practiced otherwise than as specifically described herein, without departing from the scope thereof

I claim:

1. A reward system for facilitating discount rewards between a seller, a buyer, a payment transfer agent and a reward service consisting of a seller computer, a buyer computer, a network, a payment transfer agent web site system, a reward service web site system, a payment transfer agent coupon code, emails and an HTML selling page, said reward system configured to:
(a) implement a process for said seller to establish a seller reward program;
(b) activate a first payment transfer agent coupon code for use in said seller reward program to reward said buyer for granting said buyer's opt-in permission;
(c) create a seller reward program image embedded with said activated first payment transfer agent coupon code for presentation to said buyer on said HTML selling page;
(d) receive and process a notification message from said payment transfer agent when said buyer uses said first payment transfer agent coupon code signifying said buyer opt-in permission;
(e) activate subsequent payment transfer agent coupon codes for said seller for use by said buyer in future purchases when paid through said payment transfer agent;
(f) create and send at least one email message to said buyer promoting said seller's subsequent coupon code;
(g) receive and process a notification from said payment transfer agent when said buyer uses said subsequent coupon code.

2. An automated method, performed by a computer-based reward system to reward a buyer with a discount off a purchase made from a seller when payment is made through a payment transfer agent, said reward based on use of a displayed activated first payment transfer agent coupon code, said discount as compensation for said buyer opt-in permission to said seller's reward program and email list, and to reward said buyer with an activated subsequent payment transfer agent coupon code delivered to said buyer via at least one email, said subsequent payment transfer agent coupon creating a discount reward for said buyer upon repeat purchase payment made through said payment transfer agent using said subsequent payment transfer agent coupon code, the method comprising: implementing a process for said seller to establish a seller reward program; activating a first payment transfer agent coupon code for use in said seller reward program to reward said buyer for said buyer's opt-in permission; creating a seller reward program image with said first payment transfer agent coupon code embedded, for presentation to said buyer on a HTML selling page; receiving and processing a notification message from said payment transfer agent when said buyer uses said first payment transfer agent coupon code signifying said buyer opt-in permission; activating subsequent payment transfer agent coupon codes for said seller for use by said buyer in future purchases when paid through said payment transfer agent; creating and sending at least one email message to said buyer promoting said seller's subsequent coupon codes; receiving and processing a notification from said payment transfer agent when said buyer uses said subsequent coupon codes.
